(19) United States
(12) Patent Application Publication
(10) Pub. No.: US 2016/0092890 A1
(43) Pub. Date: Mar. 31, 2016

(54) MULTIDIMENSIONAL MONITORING AND ALERTING OF BUSINESS METRICS

(71) Applicant: LinkedIn Corporation, Mountain View, CA (US)

(72) Inventors: Venkata S.J.R. Bhamidipati, Fremont, CA (US); Ashvin Kannan, Sunnyvale, CA (US); Praveen Neppalli Naga, Union City, CA (US); Deepak Kumar, Mountain View, CA (US)

(21) Appl. No.: 14/580,096

(22) Filed: Dec. 22, 2014

Related U.S. Application Data
(60) Provisional application No. 62/057,926, filed on Sep. 30, 2014.

(51) Int. Cl. G06Q 30/02; G06F 3/0482; G06Q 50/00; G06F 3/0484

(52) U.S. Cl. CPC G06Q 30/0201; G06F 3/0484; G06F 3/0482; G06Q 30/0246; G06Q 50/01

(57) ABSTRACT

Techniques for multidimensional monitoring and alerting of business metrics of an online system are described. According to various embodiments, a user specification of a business metric associated with operations of an online social networking system, and multiple dimensional values that are included in the business metric, are received. A revenue-impacting event corresponding to a change in a specific one of the dimensional values is then detected. Thereafter, it is determined that the revenue-impacting event is caused by a release of a particular online service associated with the online social networking system. A notification specifying the revenue-impacting event, and indicating that the revenue-impacting event was caused by the release of the particular online service, is then displayed.

### CROSS-REFERENCE TO RELATED APPLICATIONS

The present application claims the priority benefit of U.S. Provisional Application No. 62/057,926, filed Sep. 30, 2014, which is incorporated by reference herein in its entirety.

### TECHNICAL FIELD

The present application relates generally to data processing systems and, in one specific example, to techniques for multidimensional monitoring and alerting of business metrics of an online system.

### BACKGROUND

Online social network services such as LinkedIn® are becoming increasingly popular, with many such websites boasting millions of active members. Each member of the online social network service is able to upload an editable member profile page to the online social network service. The member profile page may include various information about the member, such as the member's biographical information, photographs of the member, and information describing the member's employment history, education history, skills, experience, activities, and the like. Such member profile pages of the networking website are viewable by, for example, other members of the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a flowchart illustrating an example method, according to various embodiments;

FIG. 4 illustrates an example portion of a user interface, according to various embodiments;

FIG. 5 illustrates an example of a homepage, according to various embodiments;

FIG. 6 illustrates an example portion of a user interface, according to various embodiments;

FIG. 7 is a flowchart illustrating an example method, according to various embodiments;

FIG. 8 illustrates an example of service information, according to various embodiments;

FIG. 9 is a flowchart illustrating an example method, according to various embodiments;

FIG. 10 is a flowchart illustrating an example method, according to various embodiments;

FIG. 11 illustrates an example mobile device, according to various embodiments; and

FIG. 12 is a diagrammatic representation of a machine in the example form of a computer system within which a set of instructions, for causing the machine to perform any one or more of the methodologies discussed herein, may be executed.

### DETAILED DESCRIPTION

Example methods and systems for multidimensional monitoring and alerting of business metrics of an online system are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various exemplary embodiments, a user may specify a business metric for an online social networking system for monitoring, such as click through rate (CTR) for a given online product, and that business metric may broken down across various dimensions such as location, advertising campaign, products/subproducts, communication channel, device type, operating system, and so on. For example, for the business metric of CTR for a particular product, this metric can be broken down based on the dimension of location into dimensional values for different locations (e.g., the clicks received from client devices in different locations), and this metric can be broken down based on the dimension of device type into dimensional values for different device types (e.g., the clicks from different client device types), and this metric can be broken down based on the dimension of operating system into dimensional values for different operating systems (e.g., the clicks from client devices having different operating systems), and this metric can be broken down based on the dimension of product/subproduct into dimensional values for different products/subproducts (e.g., the clicks received via different product modules associated with the homepage), and so on.

In some embodiments, a business metric and each of the constituent dimensional values may be monitored for drops or reductions. For example, when monitoring the business metric of CTR for a content feed, the overall CTR may not change to a great degree, but it may be difficult to quickly detect significant changes in any of the plethora of dimensional values that contribute to the content feed CTR (e.g., detecting in real-time that the content feed CTR for a given country, operating system, or device type experienced a significant drop). In some embodiments, the cause of a reduction in a dimensional value may be determined as being due to the release of an online service (e.g., a software update or version update) and, in some embodiments, the release of this online service may be automatically “rolled back” or reversed.

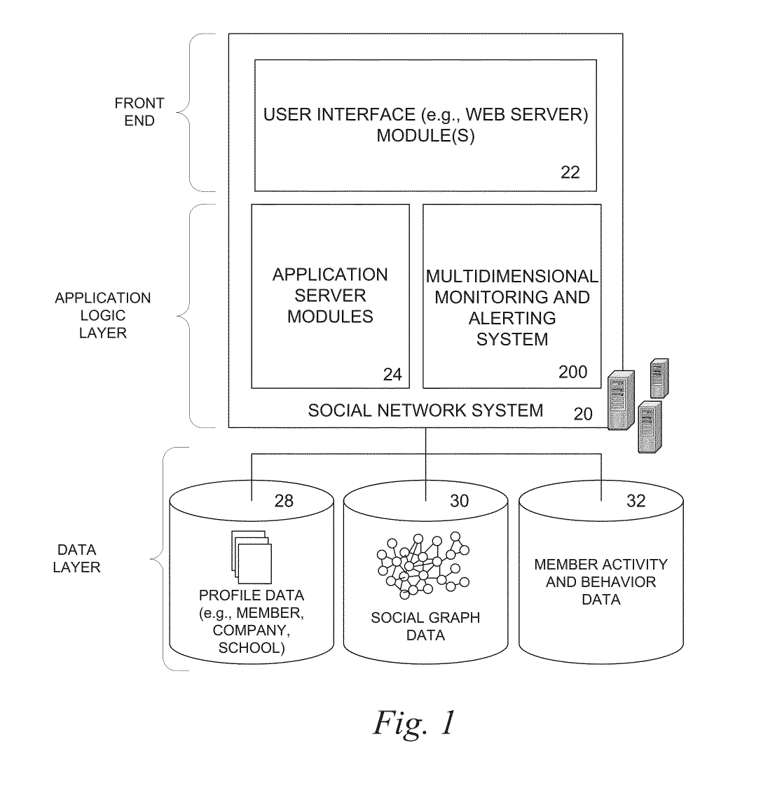

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

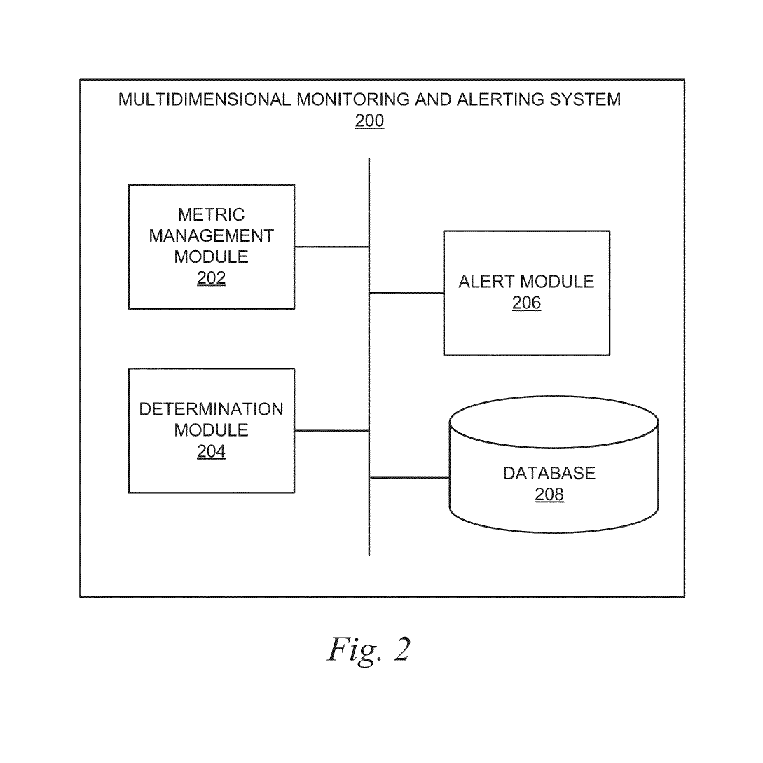

With some embodiments, the social network system 20 includes what is generally referred to herein as a multidimensional monitoring and alerting system 200. The multidimensional monitoring and alerting system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

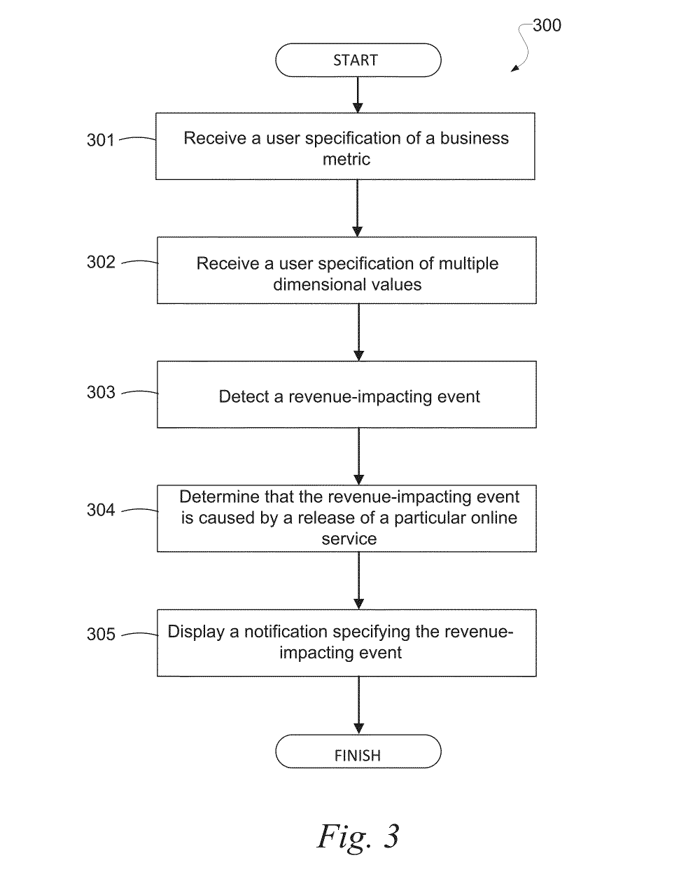

Turning now to FIG. 2, a multidimensional monitoring and alerting system 200 includes a metric management module 202, a determination module 204, an alert module 206, and a database 208. The modules of the multidimensional monitoring and alerting system 200 may be implemented on or executed by a single device such as a multidimensional monitoring and alerting device, or on separate devices interconnected via a network. The aforementioned multidimensional monitoring and alerting device may be, for example, one or more client machines or application servers. The operation of each of the aforementioned modules of the multidimensional monitoring and alerting system 200 will now be described in greater detail in conjunction with FIG. 3.

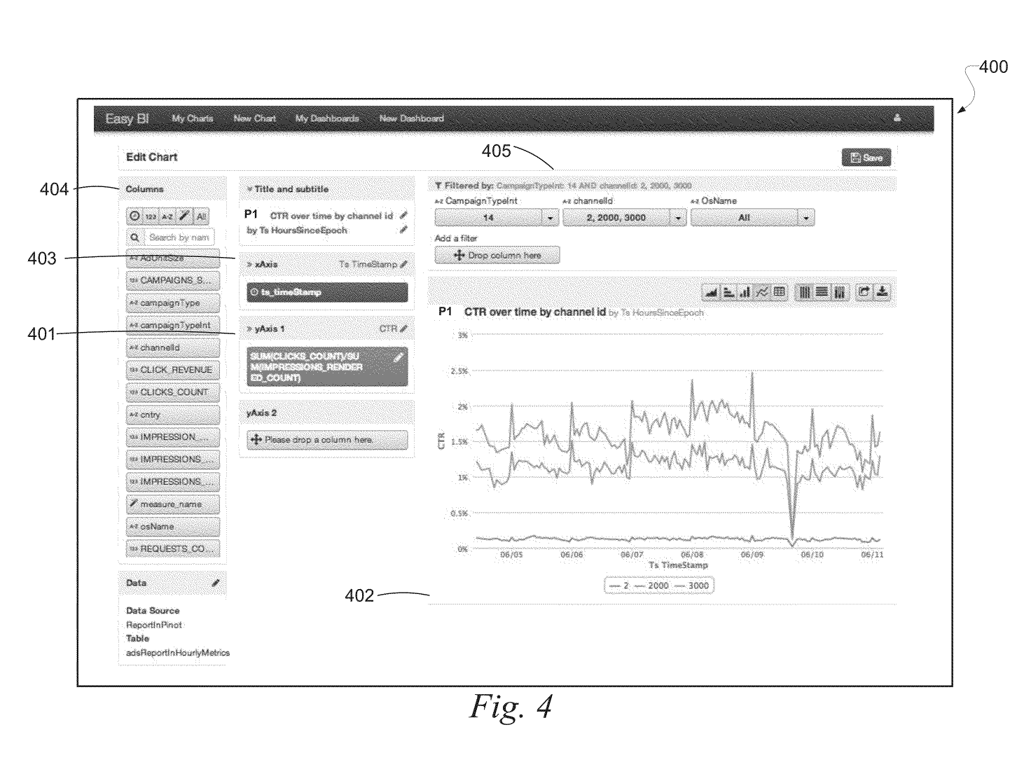

FIG. 3 is a flowchart illustrating an example method 300, consistent with various embodiments described above. The method 300 may be performed at least in part by, for example, the multidimensional monitoring and alerting system 200 illustrated in FIG. 2 (or an apparatus having similar modules, such as one or more client machines or application servers). In operation 301, the metric management module 202 receives, via one or more user interfaces, a user specification of a business metric associated with operations of an online social networking system. For example, the multidimensional monitoring and alerting system 200 may display the user interface 400 in FIG. 4 that enables the user to specify a business metric and to view a graphic 402 displaying information related to the change in the business metric over time. In this case, the user has specified the business metric of CTR for a particular product (P1). For example, the user can enter the business metric of CTR in the “yAxis 1” element so that it will be displayed in conjunction with the y-axis of the graph 402. Note that the user can enter the “Ts Time Stamp” on the “xAxis” element 403 to show the change in CTR over time.

In some embodiments, the business metric corresponds to a click through rate (CTR) associated with online content posted on the online social networking system, where CTR corresponds to a number of clicks for a piece of online content divided by the number of impressions or views for that piece of content item. The aforementioned online content may correspond to an advertisement, an article or publication (e.g., in a content feed), a particular webpage such as a homepage or a product-specific webpage associated with an online social networking system, a product module associated with anyone of various products of an online social networking system, and so on.

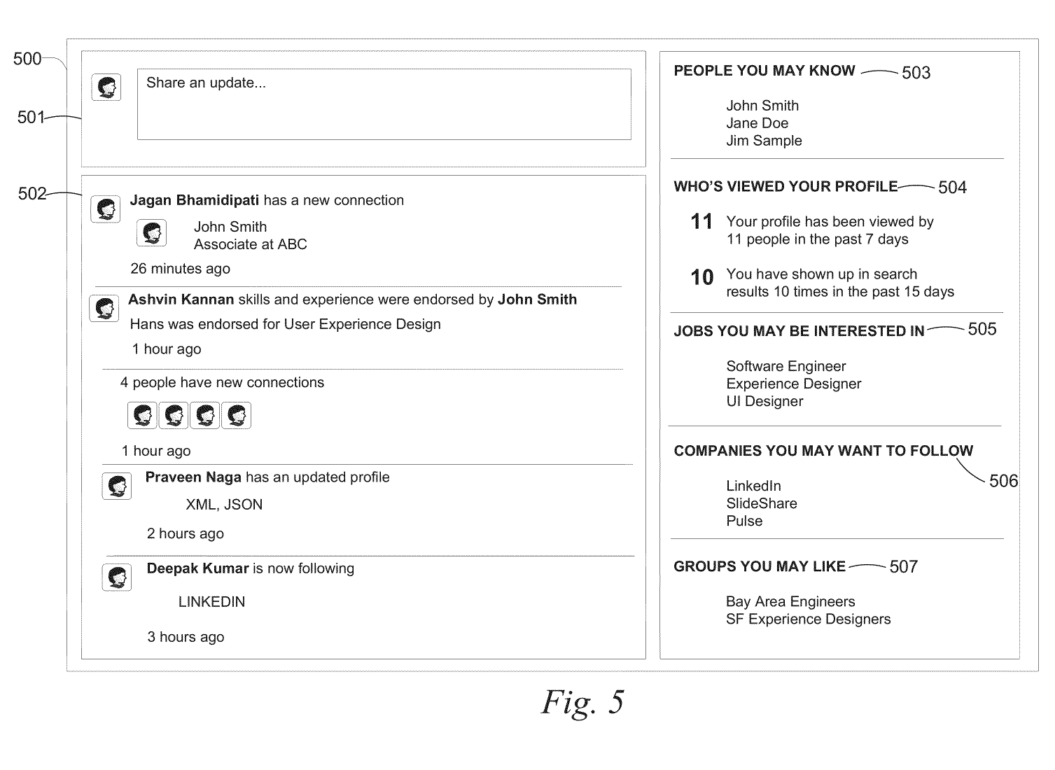

For example, FIG. 5 illustrates an exemplary webpage 500 that corresponds to a homepage of a social network service (such as LinkedIn®) that is displayed when a particular member “Jane Doe” logs into the social network service. As illustrated in FIG. 5, the home page 500 includes various webpage products, such as a profile update product 501 (that enables the member to post an update viewable by other members of the social network service), a network update stream 502 (also referred to as a content feed, newsfeed, activity feed, etc.), a “People you may know” product 503 that displays other members that may be known to the logged-in member, a “Who's viewed your profile” product 504 that displays other members that have viewed the logged-in member's profile page (e.g., during a recent time interval), a “Jobs you may be interested in” product 505 displaying jobs that may be of interest to the logged in-member, a “companies you may want to follow” product 506 displaying companies that the logged-in member may wish to follow, a “groups you may like” product 507 displaying groups that may be of interest to the logged-in member, and so on. The webpage 500 illustrated in FIG. 5 is merely exemplary, and product-specific webpages are also available (e.g., a member profile page, a company page, a product page, an advertisement page, a group page, a jobs page, a help page, a friends/connections page, etc.).

In some embodiments, the business metric corresponds to a ratio of impressions rendered to impressions served associated with online content posted on the online social networking system. For example, if the ratio is 1:1, this means that every advertisement that is “rendered” or prepared for display on client devices are actually “served” or transmitted to the client devices and displayed on the client devices. On the other hand, if the ratio is 2:1, this means that only half of the advertisements that are rendered are actually served. For many online businesses, such as those using a Cost Per Impression or Cost Per 1000 Impressions (CPM) model, the impressions rendered equates to opportunities for revenue, and impressions served directly equates to revenue for the online business. Thus, such a metrics may represent a business critical metric for an online social networking system.

Other examples of business metrics include number of advertisement served, revenue, revenue per product, revenue per ad request (e.g., a request to serve an ad) or revenue per ad click, number of ad requests received with no ad being served, and so on. It is understood that the embodiments described herein are applicable to any kind of metric that may be utilized during operations of a website, online social networking service, online business, online advertising initiative, etc.

In operation 302 in FIG. 3, the metric management module 202 receives, via one or more user interfaces, a user specification of multiple dimensional values that are included in the business metric. For example, the multidimensional monitoring and alerting system 200 may display the user interface 400 in FIG. 4 that includes a “Column” element 404 that enables the user to select a dimension, such as “CampaignTypeint” (representing the dimension of campaign), “channelid” (representing the dimension of device type), “osName” (representing the dimension of device operating system), and so on. Once selected, the user can drag and drop the selected dimension/column into the “Filtered by” area 405, where the user can select specific dimensional values of interest for each selected dimension. For example, as seen in FIG. 4, the user has selected a specific campaign type (11), 3 specific channel ids (2, 2000, 3000), and all operating systems.

In some embodiments, the multiple dimensional values in operation 302 may be all the dimensions in the “Filtered by” area 405. In alternative embodiments, the multiple dimensional values in operation 302 may be all the dimensions that have been programmed into and displayed by the “Column” element 404.

In some embodiments, the multiple dimensional values are associated with multiple geographic locations (e.g., regions, countries, states, cities, etc.) where the online social networking system operates, and the specific dimensional value is associated with a specific geographic location.

In some embodiments, the multiple dimensional values are associated with multiple advertising campaigns of the online social networking system, and the specific dimensional value is associated with a specific advertising campaign of the multiple advertising campaigns.

In some embodiments, the multiple dimensional values are associated with multiple online products of the online social networking system, and the specific dimensional value is associated with a specific online product of the multiple online products. In some embodiments, the online products may include a content feed product, a sponsored content product, a member profile product, a People-You-May-Know product, a jobs product, a Jobs-You-May-Be-Interested-In product, a groups product, a Groups-You-May-Be-Interested-In product, a schools product, a Schools-You-May-Be-Interested-In product, a companies product, a Companies-You-May-Be-Interested-In product, an Influencer product, a Influencers-You-May-Be-Interested-In product, and so on.

In some embodiments, the multiple dimensional values are associated with multiple communication channels of the online social networking system (e.g., webpage, email, text message, etc.), and the specific dimensional value is associated with a specific communication channel of the multiple communication channels. For example, for the metric of CTR with respect to a particular product (e.g., a content feed CTR), the dimensional value corresponding to the webpage communication channel may represent impressions and associated clicks of the content feed received via members viewing the content feed via an open webpage in a web browser, whereas the dimensional value corresponding to the email communication channel may represent impressions and associated clicks of the content feed received via members viewing the content feed via an email message from the online social networking system, and so on. Examples of communication channels include e-mail, text message (e.g., a short messaging service (SMS) message, a multimedia messaging service (MMS) message, etc.), an instant message associated with an online social network (e.g., Facebook, LinkedIn, Wechat, WhatsApp, etc.), a chat message associated with an online chat service, and so on.

In some embodiments, the multiple dimensional values are associated with multiple device types (e.g., desktop, tablet, mobile, etc.), and the specific dimensional value is associated with a specific device type of the multiple device types. For example, for the metric of CTR with respect to a particular product (e.g., a content feed CTR), the dimensional value corresponding to the desktop device type may represent impressions and associated clicks of the content feed received via members viewing the content feed via a desktop, whereas the dimensional value corresponding to the mobile device type may represent impressions and associated clicks of the content feed received via members viewing the content feed via a smartphone, and so on.

In some embodiments, the multiple dimensional values are associated with multiple device operating systems (Android, iOS™ from Apple Inc. of Cupertino, Calif.), and the specific dimensional value is associated with a specific device operating system of the multiple device operating systems. For example, for the metric of CTR with respect to a particular product (e.g., a content feed CTR), the dimensional value corresponding to the Android operating system may represent impressions and associated clicks of the content feed received via members viewing the content feed via a device with the Android operating system, whereas the dimensional value corresponding to the iOS operating system may represent impressions and associated clicks of the content feed received via members viewing the content feed via a device with the iOS operating system, and so on.

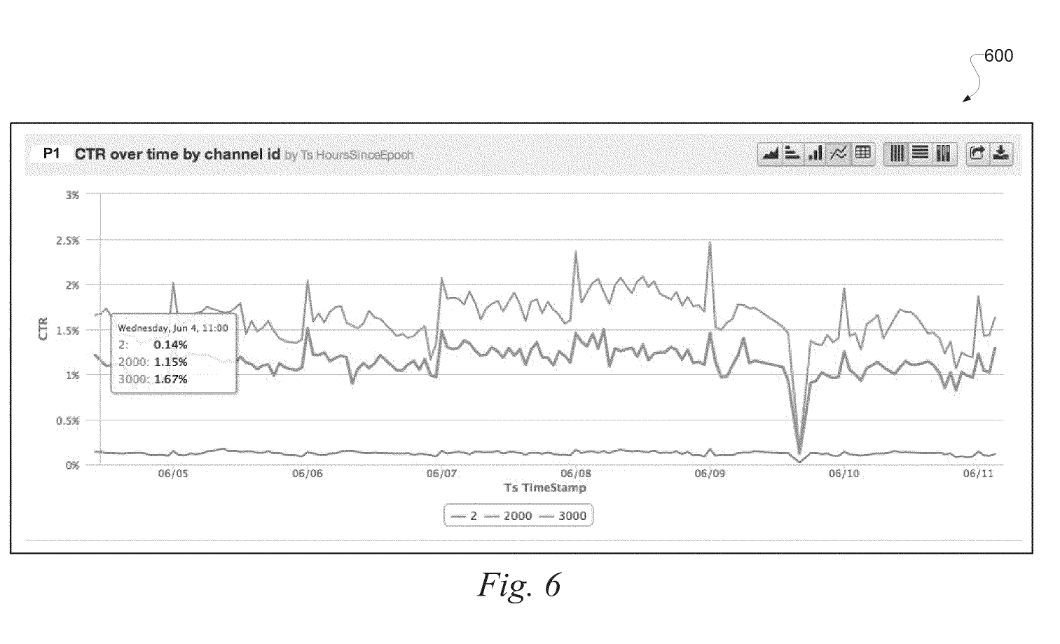

In operation 303 in FIG. 3, the determination module 204 detects a revenue-impacting event corresponding to a change (e.g., increase or decrease) in a specific one of the dimensional values. For example, the determination module 204 may detect that a specific dimensional value has decreased or increased by a predetermined threshold percentage (e.g., 5%), perhaps within a predetermined time interval (e.g., 3 seconds, 1 minute, etc.). As another example, the determination module 204 may detect that the specific dimensional value has decreased or increased by a predetermined threshold value or decreased to below (or increased to above) a predetermined threshold value (e.g., 0.5% CTR), perhaps within a predetermined time interval (e.g., 3 seconds, 1 minute, etc.). For example, as illustrated in FIG. 4, the determination module 204 will detect the drop in CTR for the dimensional values of channelid 2000 and 3000 on June 9, as illustrated in the graph 402, and as shown in more detail in FIG. 6. As another example, if the metric is “number of ad requests received with no ad being served”, and if a dimensional value associated this metric rises above a predetermined threshold, this indicates that too many ad requests are being returned with no ad being properly served. The multidimensional monitoring and alerting system 200 may display a user interface allowing an operator of the multidimensional monitoring and alerting system 200 (e.g., employees of the online social networking system) to specify the aforementioned predetermined threshold percentage or predetermined threshold value.

In operation 304 in FIG. 3, the determination module 204 determines that the revenue-impacting event is caused by a release of a particular online service associated with the online social networking system. In some embodiments, the particular online service corresponds to a software update (e.g., a version update) to an online product associated with the online social networking system. For example, the determination module 204 may determine that a drop in content feed CTR for client devices with the Android operating system is caused by a recently released software update to the content feed for client devices with the Android operating system. This process is described in greater detail below.

In operation 305 in FIG. 3, the alert module 206 displays a notification specifying the revenue-impacting event and indicating that the revenue-impacting event was caused by the release of the particular online service. Using the example above, the alert module 206 may display a notification indicating that there was a drop in content feed CTR for client devices with the Android operating system is caused by a recently released software update to the content feed for client devices with the Android operating system. The notification may be displayed as a window in a webpage or in a message. It is contemplated that the operations of method 300 may incorporate any of the other features disclosed herein. Various operations in the method 300 may be omitted or rearranged, as necessary.

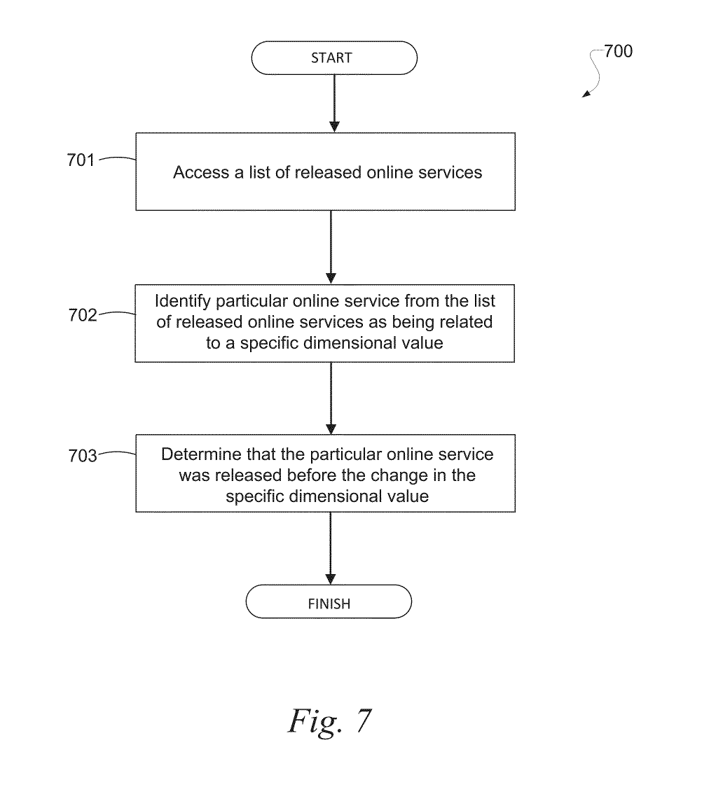

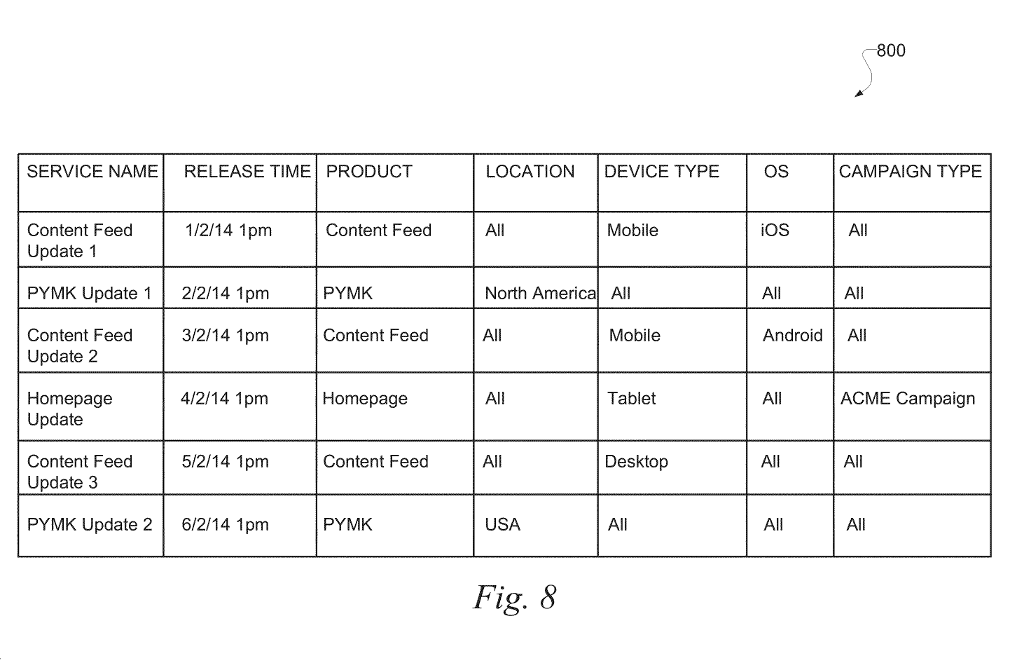

FIG. 7 is a flowchart illustrating an example method 700 for determining that a revenue-impacting event is caused by a release of a particular online service (e.g., see operation 304 in FIG. 3), consistent with various embodiments described above. The method 700 may be performed at least in part by, for example, the multidimensional monitoring and alerting system 200 illustrated in FIG. 2 (or an apparatus having similar modules, such as one or more client machines or application servers). In operation 701, the determination module 204 accesses a list of released online services. For example, the determination module 204 may access the service information 800 illustrated in FIG. 8 that identifies various services (e.g., software updates or version updates) recently released on an online social networking service. The service information 800 may be stored locally at, for example, the database 208 illustrated in FIG. 2, or may be stored remotely at a database, data repository, storage server, etc., that is accessible by the multidimensional monitoring and alerting system 200 via a network (e.g., the Internet). In operation 702, the determination module 204 identifies a particular online service from the list of released online services as being related to a specific dimensional value for which a change was detected (e.g., in operation 303 in FIG. 3). For example, the determination module 204 may consult the service information 800 illustrated in FIG. 8 that identifies various services (e.g., software updates or version updates) recently released on an online social networking service, as well as various dimensional information associated with each service (e.g., relevant product, location, device type, OS, campaign type, etc.). Thus, if there was a CTR drop for a specific dimensional value such as a location corresponding to Canada, the determination module 204 will determine that all the services except PYMK Update 2 are related to this specific dimensional value for the given business metric. As another example, if there was a content feed CTR drop for a dimensional value such as an OS corresponding to iOS, the determination module 204 will determine that the Content Feed Update 1 service is related to this specific dimensional value for the given business metric. In operation 703, the determination module 204 determines that the particular online service was released within a predetermined time interval (e.g., 1 minute, 1 hour, etc.) before the change in the specific dimensional value. For example, the determination module 204 may compare the time of the change with the release date/time for the relevant online service in the service information 800. The result of operation 703 may be a list of one or more “candidate cause online services” that may represent candidate causes for revenue-impacting events. It is contemplated that the operations of method 700 may incorporate any of the other features disclosed herein. Various operations in the method 700 may be omitted or rearranged, as necessary.

In some embodiments, the determination module 204 may ensure that the correct cause of a change has been determined (e.g., candidate cause online services identified in conjunction with method 700), by analyzing all the dimensional values associated with a business metric and confirming that the release of the candidate cause online service is consistent with any reductions in any of the multiple dimensional values associated with the business metric. For example, if there was a reduction in content feed CTR for the Android operating system, then a released service related to Android may possibly be the cause of the issue. However, if there was also a reduction in content feed CTR for the iOS operating system at the same time, then the released service related to Android is likely not the cause of the reductions for both the Android OS and the iOS OS, but rather there may be another OS-independent reason for the issue. Thus, the determination module 204 checks all the dimensional values associated with a candidate cause online service to confirm that there was were reductions in all of them at the same time, and the determination module 204 checks all the dimensional values not associated with a candidate cause online service to confirm that there were not reductions in all of them at the same time.

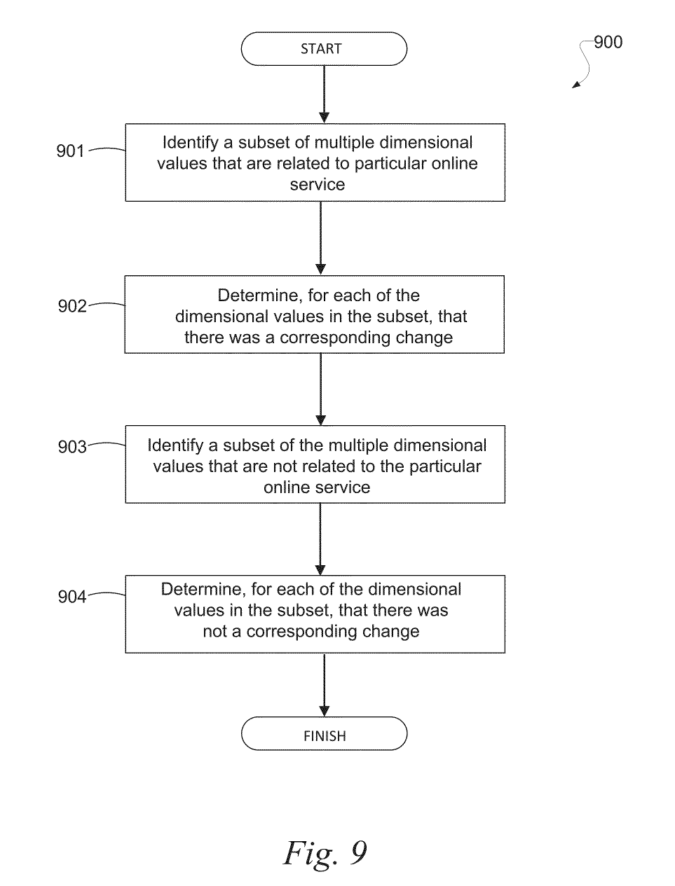

FIG. 9 is a flowchart illustrating an example method 900 for determining that a revenue-impacting event is caused by a release of a particular online service (e.g., see operation 304 in FIG. 3), consistent with various embodiments described above. The method 900 may be performed at least in part by, for example, the multidimensional monitoring and alerting system 200 illustrated in FIG. 2 (or an apparatus having similar modules, such as one or more client machines or application servers). In operation 901, the determination module 204 identifies a subset of multiple dimensional values (e.g., as specified by a user in operation 302 in FIG. 3) that are related to a particular online service (e.g., a candidate cause online service identified in conjunction with method 700). For example, the metric management module 202 may consult service information 800 to identify all the dimensional values associated with a given online service (e.g., all locations in North America are associated with PYMK update 1 in FIG. 8). In operation 902, the determination module 204 determines, for each of the dimensional values in the subset identified in 901, that there was a corresponding change (e.g., decrease or increase) in the corresponding dimensional value at the same time. For example, the determination module 204 confirms that, for a given online service, there was a drop in all relevant dimensional values at the same time. For example, for the Content Feed Update 1 in FIG. 8, the determination module 204 will confirm that there was a reduction for all countries, and for the PYMK update 1, the determination module 204 will confirm that there was as reduction for all North American countries, etc. In operation 903, the determination module 204 identifies a subset of the multiple dimensional values that are not related to the particular online service. For example, the metric management module 202 may consult service information 800 to identify all the dimensional values not associated with a given online service (e.g., no locations outside North America are associated with PYMK update 1). In operation 904, the determination module 204 determines, for each of the dimensional values in the subset identified in operation 903, that there was not a corresponding change (e.g., decrease or increase) in the corresponding dimensional value. In other words, the determination module 204 confirms that a given online service could not have caused a change in dimensional values not related to that service. For example, for the PYMK update 1 in FIG. 8, the determination module 204 will confirm that there was no simultaneous drop outside North American countries. It is contemplated that the operations of method 900 may incorporate any of the other features disclosed herein. Various operations in the method 900 may be omitted or rearranged, as necessary. For example, operations 903 and 904 may occur before operations 901 and 902. As another example, operations 901 and 902 may be omitted. As another example, operations 903 and 904 may be omitted.

In some embodiments, the determination module 204 generates a confidence value indicating a likelihood that a particular online service is the cause of a revenue-impacting event (e.g., a decrease in a specific dimensional value). For example, after method 700 in FIG. 7, the determination module 204 may generate a list of candidate cause online services, and may then associate a base confidence score with each candidate cause online service. The determination module 204 may then adjust the confidence score for a given candidate cause online service depending on the result of operations 902 and 904 (e.g., if more dimensional values associated with an online service had reductions, increase the corresponding confidence score, and if more dimensional values not associated with an online service didn't have reductions, increase the corresponding confidence score). This may be beneficial in case where two different services (e.g., iOS update and Android update released simultaneously) may be defective and resulting in drops in different dimensional values.

As described above, the alert module 206 may display a notification specifying a revenue-impacting event and indicating that the revenue-impacting event was caused by the release of the particular online service. In some embodiments, the alert module 206 may instead or in addition display a notification that includes a recommendation that the release of the particular online service be “rolled back” or reversed (e.g., to a previous state, version, or software update).

In some embodiments, the alert module 206 may automatically “rolls back” or reverses the release of the particular online service (e.g., to a previous state, version, or software update). For example, if the determination module 204 generates a confidence value indicating a likelihood that a particular online service is the cause of a revenue-impacting event (e.g., a decrease or increase in a specific dimensional value) as described above, then the alert module 206 may reverse the release of the particular online service if the confidence value is greater than a predetermined threshold. The multidimensional monitoring and alerting system 200 may display a user interface enabling an operator of the multidimensional monitoring and alerting system 200 (e.g., personnel or employees of an online social networking system) to specify the aforementioned predetermined threshold.

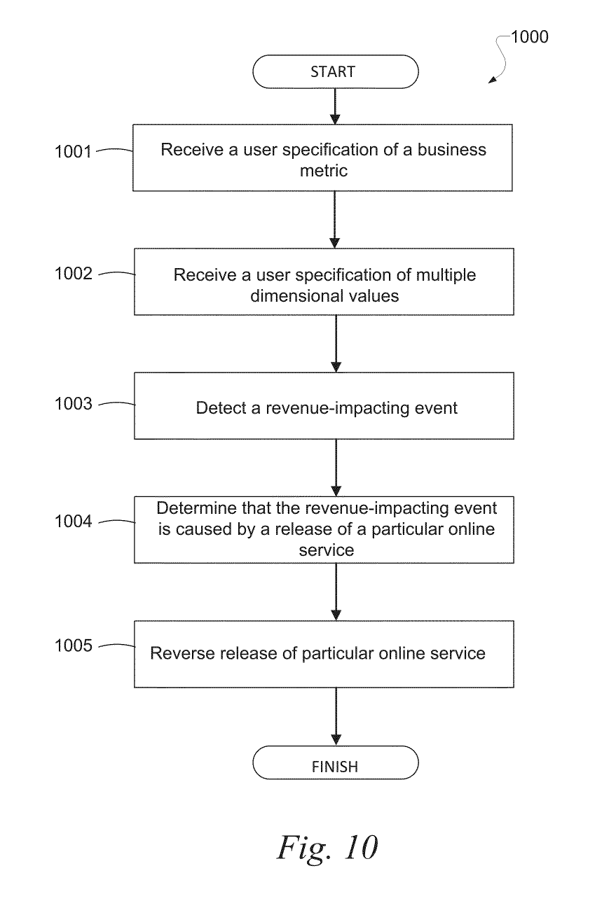

FIG. 10 is a flowchart illustrating an example method 1000, consistent with various embodiments described above. The method 1000 may be performed at least in part by, for example, the multidimensional monitoring and alerting system 200 illustrated in FIG. 2 (or an apparatus having similar modules, such as one or more client machines or application servers). In operation 1001-1004 are similar to operations 301-304 in FIG. 3. In operation 1005, the alert module 206 automatically reverses the release of the particular online service identified in operation 1004. It is contemplated that the operations of method 1000 may incorporate any of the other features disclosed herein. Various operations in the method 1000 may be omitted or rearranged, as necessary.

### Example Mobile Device

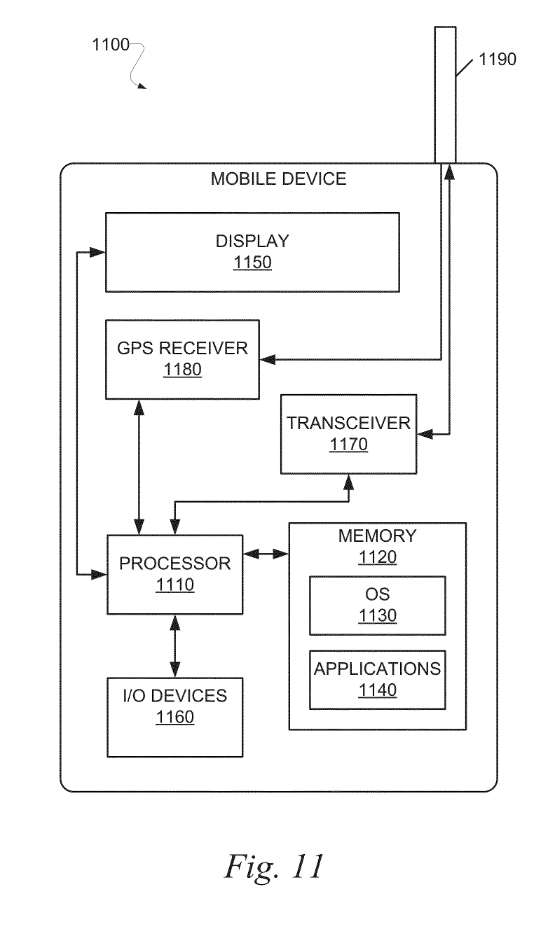

FIG. 11 is a block diagram illustrating the mobile device 1100, according to an example embodiment. The mobile device may correspond to, for example, one or more client machines or application servers. One or more of the modules of the system 200 illustrated in FIG. 2 may be implemented on or executed by the mobile device 1100. The mobile device 1100 may include a processor 1110. The processor 1110 may be any of a variety of different types of commercially available processors suitable for mobile devices (for example, an XScale architecture microprocessor, a Microprocessor without Interlocked Pipeline Stages (MIPS) architecture processor, or another type of processor). A memory 1120, such as a Random Access Memory (RAM), a Flash memory, or other type of memory, is typically accessible to the processor 1110. The memory 1120 may be adapted to store an operating system (OS) 1130, as well as application programs 1140, such as a mobile location enabled application that may provide location based services to a user. The processor 1110 may be coupled, either directly or via appropriate intermediary hardware, to a display 1150 and to one or more input/output (I/O) devices 1160, such as a keypad, a touch panel sensor, a microphone, and the like. Similarly, in some embodiments, the processor 1110 may be coupled to a transceiver 1170 that interfaces with an antenna 1190. The transceiver 1170 may be configured to both transmit and receive cellular network signals, wireless data signals, or other types of signals via the antenna 1190, depending on the nature of the mobile device 1100. Further, in some configurations, a GPS receiver 1180 may also make use of the antenna 1190 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

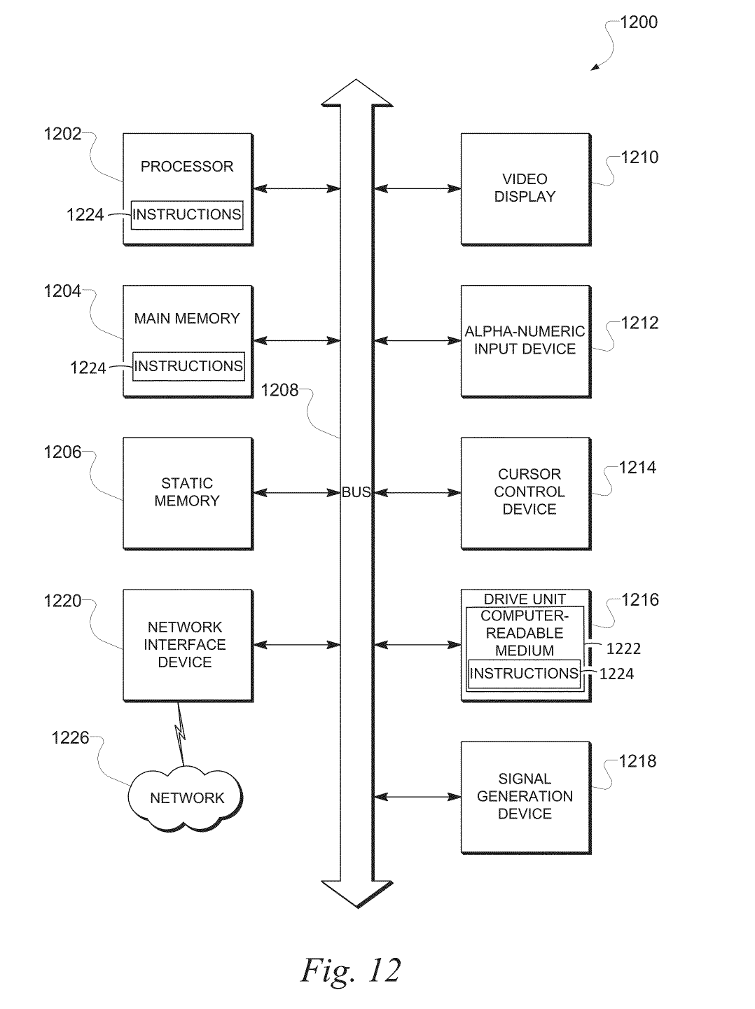

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, via one or more user interfaces, a user specification of a business metric associated with operations of an online social networking system;
receiving, via the one or more user interfaces, a user specification of multiple dimensional values that are included in the business metric;
detecting a revenue-impacting event corresponding to a change in a specific one of the dimensional values;
determining, using one or more hardware processors, that the revenue-impacting event is caused by a release of a particular online service associated with the online social networking system; and
displaying a notification specifying the revenue-impacting event and indicating that the revenue-impacting event was caused by the release of the particular online service.

2. The method of claim 1, wherein the business metric corresponds to a click through rate (CTR) associated with online content posted on the online social networking system.

3. The method of claim 1, wherein the business metric corresponds to a ratio of impressions rendered to impressions served associated with online content posted on the online social networking system.

4. The method of claim 1, wherein the particular online service corresponds to a software update to an online product associated with the online social networking system.

5. The method of claim 1, wherein the detecting the revenue-impacting event further comprises detecting that the specific dimensional value has changed by a predetermined threshold percentage.

6. The method of claim 1, wherein the detecting the revenue-impacting event further comprises detecting that the specific dimensional value has changed by a predetermined threshold value.

7. The method of claim 1, wherein the determining that the revenue-impacting event is caused by the release of the particular online service further comprises:
accessing a list of released online services;
identifying the particular online service from the list of released online services as being related to the specific dimensional value; and
determining that the particular online service was released within a predetermined time interval before the change in the specific dimensional value.

8. The method of claim 1, wherein the determining that the revenue-impacting event is caused by the release of the particular online service further comprises:
identifying a subset of the multiple dimensional values that are related to the particular online service; and
determining, for each of the dimensional values in the subset, that there was a corresponding change in the corresponding dimensional value.

9. The method of claim 1, wherein the determining that the revenue-impacting event is caused by the release of the particular online service further comprises:
identifying a subset of the multiple dimensional values that are not related to the particular online service; and
determining, for each of the dimensional values in the subset, that there was not a corresponding change in the corresponding dimensional value.

10. The method of claim 1, further comprising:
displaying a notification that includes a recommendation that the release of the particular online service be reversed.

11. The method of claim 1, further comprising:
automatically reversing the release of the particular online service.

12. The method of claim 1, wherein the multiple dimensional values are associated with multiple geographic locations where the online social networking system operates, and
wherein the specific dimensional value is associated with a specific geographic location

13. The method of claim 1, wherein the multiple dimensional values are associated with multiple advertising campaigns of the online social networking system, and
wherein the specific dimensional value is associated with a specific advertising campaign of the multiple advertising campaigns.

14. The method of claim 1, wherein the multiple dimensional values are associated with multiple online products of the online social networking system, and
wherein the specific dimensional value is associated with a specific online product of the multiple online products.

15. The method of claim 14, wherein the multiple online products include a content feed, a member profile product, a jobs product, a groups product, a schools product, a companies product, and an Influencer product.

16. The method of claim 1, wherein the multiple dimensional values are associated with multiple communication channels of the online social networking system, and
wherein the specific dimensional value is associated with a specific communication channel of the multiple communication channels.

17. The method of claim 1, wherein the multiple dimensional values are associated with multiple device types, and
wherein the specific dimensional value is associated with a specific device type of the multiple device types.

18. The method of claim 1, wherein the multiple dimensional values are associated with multiple device operating systems, and
wherein the specific dimensional value is associated with a specific device operating system of the multiple device operating systems.

19. A system comprising:
a metric management module, comprising one or more hardware processors, configured to:
receive, via one or more user interfaces, a user specification of a business metric associated with operations of an online social networking system; and
receive, via the one or more user interfaces, a user specification of multiple dimensional values that are included in the business metric;
a determination module, comprising the one or more hardware processors, configured to:
detect a revenue-impacting event corresponding to a change in a specific one of the dimensional values; and
determine that the revenue-impacting event is caused by a release of a particular online service associated with the online social networking system; and
an alert module, comprising the one or more hardware processors, configured to display a notification specifying the revenue-impacting event and indicating that the revenue-impacting event was caused by the release of the particular online service.

20. A non-transitory machine-readable storage medium comprising instructions that, when executed by one or more processors of a machine, cause the machine to perform operations comprising:
receiving, via one or more user interfaces, a user specification of a business metric associated with operations of an online social networking system;
receiving, via the one or more user interfaces, a user specification of multiple dimensional values that are included in the business metric;
detecting a revenue-impacting event corresponding to a change in a specific one of the dimensional values;
determining that the revenue-impacting event is caused by a release of a particular online service associated with the online social networking system; and
displaying a notification specifying the revenue-impacting event and indicating that the revenue-impacting event was caused by the release of the particular online service.
